(19) United States
(12) Patent Application Publication
(10) Pub. No.: US 2024/0005054 A1
(43) Pub. Date: Jan. 4, 2024

(54) Methodfor modeling blade dimensional chains considering tenon-mortise connections

(71) Applicant: SHANGHAI JIAO TONG UNIVERSITY, Shanghai (CN)

(72) Inventors: Zhimin LI, Shanghai (CN); Wei Yuan, Shanghai (CN); Tao Liu, Shanghai (CN); Yuping Wu, Shanghai (CN); Hehe Kang, Shanghai (CN)

(21) Appl. No.: 18/324,160

(22) Filed: May 26, 2023

Related U.S. Application Data
(63) Continuation of application No. PCT/CN2023/085974, filed on Mar. 4, 2023.

(30) Foreign Application Priority Data
Jul. 1, 2022 (CN) 202210766936X

(51) Int. Cl. G06F 30/17

(52) U.S. Cl. CPC G06F 30/17; G06F 2111/10

(57) ABSTRACT

The present invention discloses a blade dimensional chain modeling method considering mortise-tenon connection, which relates to the technical field of aerospace component assembly deviation analysis. The blade dimensional chain modeling method described in the present invention can be used not only for the position deviation prediction in the initial state of the blade tip after assembly, but also for the deviation analysis of any position of the blade. The method is an explicit mathematical model with the characteristics of simplicity and high efficiency of solution.

### TECHNICAL FIELD

The present invention relates to the technical field of aerospace component assembly deviation analysis, specifically a method for modeling blade dimensional chains considering tenon-mortise connections.

### BACKGROUND TECHNOLOGY

An aero-engine is a highly complex and sophisticated thermal machinery, which is regarded as the “crown jewel” of the industry. The operational efficiency of an aero-engine depends on various factors such as structural design, material properties and manufacturing quality. Among them, the manufacturing quality and the geometric error of the components show a great correlation, the overall dynamic balance of the engine performance, operational safety have a greater impact. With the development of gas turbine engines, the efficiency, life and safety requirements of its components are also increasingly high, and the assembly quality has a great impact on the performance and structural safety of the engine.

As a common key component in aero engines, the manufacturing and assembly quality of the blade-disk assembly directly affects the service performance of the whole aircraft. Due to the complex geometric structure of the blade-disc structure, the processing and manufacturing processes are numerous, involving milling, drawing and pinning, polishing, heat treatment and other manufacturing processes. Leaf-disk structure parts in the manufacturing and assembly process, due to manufacturing errors, measurement errors and installation errors caused by leaf-disk structure geometric parameters with random characteristics. The geometry, shape and position of the blade and the disc will fluctuate in the corresponding spatial domain, resulting in uncertainty in the spatial attitude of the leaf-disc structure. The spatial position, geometry, contact tightness, load direction and contact area of discontinuous connection interfaces such as tenon/tenon slot, crown and convex shoulder will also produce variations, while the variation of the spatial position of the blade tip will also directly affect the dynamic response of the blade-disc structure. For example, if the turbine tip clearance is too small, serious friction will occur between the leading edge of the blade and the magazine bushing. Too large a clearance, on the other hand, will increase the fuel consumption rate.

Vibration troubleshooting practice shows that the current serious vibration problems caused by aero-engine and gas turbine rotor blade is mainly due to the dynamic characteristics of the parameters of the change interval is difficult to control. The reason is that the distribution of machining errors, the combination of tolerances caused by the assembly process and the probability distribution of changes in structural characteristic parameters under operating conditions cannot be determined yet, resulting in the random nature of the deformation of the assembly connection interface of the blade-disc structure. The transmission path and accumulation form of the manufacturing assembly deviation of the leaf-disk structure assembly in three-dimensional space are not clear. Therefore, the dimensional chain analysis and deviation prediction of the turbine blade-disc structure of aero-engine play an important role in improving the engine performance, prolonging the engine service life and reducing the exhaust emission.

At present, the tolerance design of rotor-blade parts is mostly based on experience and requires repeated trial and error to meet the requirements, while the tolerance analysis is still based on the traditional one-two dimensional chain. In the actual production assembly process, the parts are three-dimensional, so the one-/two-dimensional dimensional chain cannot fully reflect the coupling between dimensional tolerance, shape tolerance and assembly features, which leads to inaccurate analysis results and cannot provide an accurate basis for performance calibration and tolerance optimization allocation. For the more complex three-dimensional shape and position tolerances that may be involved in the assembly of the leaf-disk structure, the traditional method can no longer reflect the transfer and accumulation of the actual assembly dimensional chain more accurately.

Therefore, it is necessary to study the complex form tolerance expression oriented to the discontinuous interface of the leaf-disk structure connection structure. Based on the manufacturing and assembly accuracy of blade and disc geometric elements and the matching relationship of structural tenon connection, a three-dimensional deviation prediction model of the leaf-disc discontinuous connection structure containing series and parallel dimensional chains is established. It provides guidance for blade manufacturing optimization, tolerance allocation and blade performance regulation.

### CONTENT OF THE INVENTION

It is an object of the present invention to provide a method for modeling a blade dimensional chain considering a mortise-tenon connection to solve the problems mentioned in the background above.

To achieve the above purpose, the present invention provides the following technical solution:

A method for modeling a blade dimensional chain considering a tenon-tenon connection, comprising the following steps:
Step 1: establishing the tolerance types of key geometric elements required for the blade dimensional chain model and the tolerance values according to the matching relationship between the blade and the wheel assembly and the tolerance requirements in the actual manufacturing process;
Step 2: characterize the tolerances of each key geometric element based on the small displacement spin theory and establish the spin model of the deviation of each key geometric element of the wheel-disk-blade;
Step 3: Considering that the mortise and tenon joint structure of the blade-disk has many matching surfaces of the mortise and tenon slot, which is a typical complex local multi-parallel dimensional chain; taking the matching connection form of the mortise and tenon slot as an equivalent spin model of the contact pair;
Step 4: Based on the spatial position relationship between each key geometric element of the blade-disk and the blade tip, as well as the spin volume model of each functional unit in the dimensional chain, an assembly deviation analysis model of the blade-disk structure is established using Jacobi-spin volume theory; based on this model, the initial assembly deviation and spatial attitude prediction of the blade considering the mortise and tenon connection with the wheel disk are characterized.

On the basis of the above technical solutions, the invention also provides the following optional technical solutions:

In one optional embodiment: the key geometric elements required for said blade dimensional chain model include the contour degree of each matching surface at the blade tenon position, the contour degree of each matching surface at the wheel disc tenon position and the position degree of the leaf tip relative to the leaf root.

In an alternative embodiment: the specific steps in said step 3 are as follows:
Step 1: the deviations of the tenon and mortise matching surfaces in the blade-wheel disc assembly structure are characterized by small displacement rotations, i.e. the actual deviating surfaces have three deviations in the x/y/z directions of translation and three deviations of rotation along the x/y/z directions relative to the nominal surface;
Step 2: Establish a local coordinate system at the center of each matching surface, and establish the deviation plane equations of each tenon joint matching surface in the respective coordinate system based on the matching surface rotation and translational deviations; and
Step 3: calculating the amount of clearance and interference between the contact points of each matching surface of the tenon of the leaf root and the tenon groove of the wheel disc relative to the nominal value in the installation direction;
Step 4: Rank the corresponding amount of interference in each matching surface containing deviation between the tenon and the mortise groove. Considering that in the actual assembly, the matching surface is the first to contact the place with the largest amount of interference relative to the nominal position, it is the contact point of the matching surface with the larger amount of interference that plays the actual limiting role in the assembly process. Since it takes at least three contact points to determine a positioning plane. the present invention uses the plane formed by the first three points with the largest amount of interference as the equivalent positioning plane for the assembly of the mortise and tenon slot;
Step 5: establishing a coordinate system conversion matrix based on the position relationship between the local and global coordinate systems, and using the three positioning points of the equivalent positioning plane in the mortise and tenon joint structure determined in step 4, transforming the positioning points of this equivalent positioning plane into points in the global coordinate system based on the coordinate conversion matrix;
Step 6: establishing the nominal plane equations and the plane equations with deviations for the equivalent locating surfaces of the tenon and the tenon slot, respectively, in the global coordinate system;
Step 7: Comparing the plane equation with deviation of the positioning plane obtained in Step 6 with the nominal plane equation to obtain the angular deviation and position deviation of the deviated plane with respect to the nominal equivalence plane, and thus obtain the spin volume model of the equivalent equivalence plane of the mortise and tenon joint.

In an optional solution: the point in the calculation of the overfill in step 3 is the overfill point, and the overfill point is used as the actual contact point during assembly.

In an optional solution: the following definitions are used in the assembly deviation analysis model of the blade-disk structure built using Jacobi-spinor theory: the geometric feature elements of individual parts or between parts in the assembly are functional units; internal functional units, geometric feature elements located inside a single part, which have a constraint relationship with each other and two of them form an internal constraint pair, referred to as internal sub; contact functional units, geometric elements located on the connecting features of different parts, which have a direct or indirect contact relationship with each other, and two by two form an external constraint pair, referred to as contact sub; functional requirements, i.e. dimensional accuracy requirements of the closed ring, are the target measurement and control quantities after the final assembly is completed.

In an optional scheme: the geometric feature elements include solid elements and virtual elements; wherein, the column surface and endface features of the cylinder are solid elements and the cylindrical rotation axis is a virtual element.

Compared with the prior art, the beneficial effects of the present invention are as follows:

The dimensional chain modeling method of the blade described in the present invention can characterize the transfer and accumulation of complex three-dimensional tolerances in the blade-disk assembly process. Based on this method, the influence law and contribution of the tolerance or deviation size of any dimensional ring in the dimensional chain on the target deviation of the blade can be obtained.

The blade dimensional chain modeling method described in the present invention considers the connection and contact relationship between the tenon of the leaf root and the tenon slot of the wheel disc, equates the complex local parallel dimensional chain, and solves the problem that the local dimensional chain is difficult to represent due to the uncertainty of the transmission path of deviation between the matching surfaces of the tenon connection.

The blade dimensional chain modeling method described in the present invention can be used not only for the prediction of position deviation in the initial state of the blade tip after assembly, but also for the analysis of deviation in any position of the blade. The method belongs to the explicit mathematical model, which has the characteristics of simplicity and high efficiency of solution.

The blade dimensional chain modeling method described in the present invention can obtain the fluctuation range of the target table deviation by the extreme value method, and also calculate the statistical distribution of the target geometric elements by Monte Carlo simulation. For different types of deviation distributions that may exist in actual engineering, such as normal distribution, Pearson distribution, etc., they can also be solved by this dimensional chain model. The dimensional chain modeling method described in the present invention has good engineering application capability.

The method is universal and can be used for dimensional chain analysis of any blade containing tenon-tenon connection form, such as dovetail blade, fir blade, crowned blade, etc. In addition, the blade containing tenon-tenon connection form mentioned in the present invention can be not only an aero-engine blade, but also a turbine air turbine blade, etc.

### DESCRIPTION OF THE ATTACHED DRAWINGS

FIG. 1 shows a schematic diagram of a typical aero-engine blade-disc structure.

FIG. 2 shows the characterization of spin volume under typical tolerance type.

FIG. 3 shows a schematic diagram of the leaf-disk structure with deviations in the assembled state.

FIG. 4 shows the dimensional chain transfer of the leaf-disk assembly with tenon joint structure.

FIG. 5 Schematic diagram of the local multi-parallel dimensional chain and local coordinate system for the mortise and tenon joint structure.

FIG. 6 Schematic diagram of the actual positioning points on the matching surface of the mortise and tenon joint.

FIG. 7 Schematic diagram of the equivalent positioning surface of the tenon joint structure.

FIG. 8 Schematic diagram of the equivalent locating surface and locating points of the mortise and tenon joint.

FIG. 9 Schematic diagram of statistical distribution of leaf tip position deviation.

### SPECIFIC EMBODIMENTS

In order to make the object, technical solution and advantages of the present invention more clearly understood, the present invention is described in further detail hereinafter in conjunction with the accompanying drawings and embodiments; in the accompanying drawings or descriptions, similar or identical parts use the same designation, and the shape, thickness or height of the parts may be enlarged or reduced in practical application. The embodiments of the invention are set forth for the purpose of illustrating the invention only and are not intended to limit the scope of the invention.

Any obvious modifications or changes to the present invention do not depart from the spirit and scope of the present invention.

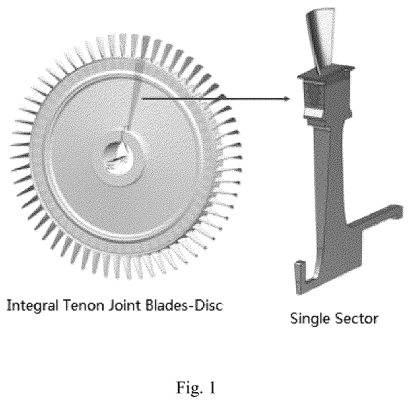

As shown in FIG. 1, the object depicted in this embodiment of the invention is a typical aero-engine turbine disk and blade assembly. In particular, the outermost part of the turbine disk has a number of mortise and tenon grooves uniformly distributed along the circumference. The tenon grooves are shaped like a dovetail or fir type. The blade shape is typical of an aero-engine blade, and the shape at the root of the blade is consistent with the tenon grooves of the turbine disk, and the tenon and the tenon grooves are in close contact with each matching surface during assembly.

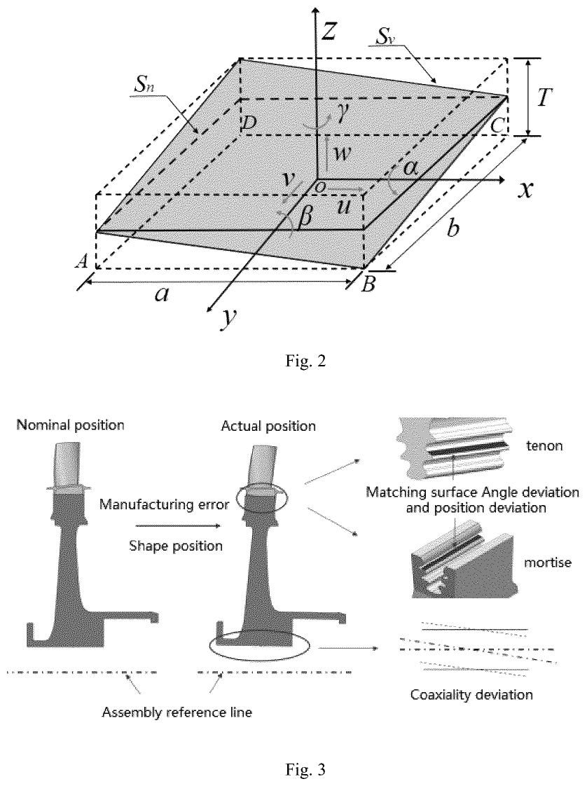

Based on the above described blade and wheel, a blade dimensional chain model considering the mortise-tenon slot connection is established. The specific steps are as follows:
Step 1, according to the matching relationship between the blade and the wheel disc during assembly and the tolerance requirements in the actual manufacturing process, define the tolerance types of each key geometric element and the tolerance values. Such as the coaxiality of the axial center of the wheel disk relative to the assembly reference, the contour degree of the matching surface in the tenon slot of the wheel disk in contact with the tenon, the contour degree of the matching surface in the tenon of the blade in contact with the tenon slot, the position degree of the top of the blade relative to the root, etc.
Step 2: Characterize the tolerances of each key geometric element based on the small displacement rotation theory. The spin volume characterization under common typical tolerance types is shown in FIG. 2, where Sv is the actual deviation plane, Sn is the nominal plane, δα, δβ, δγ are the rotation angle deviations about x/y/z axes, and δu, δv, δw are the translational deviations about x/y/z axes. According to the tolerance requirements in step 1, the corresponding rotation model is established.

Specifically, there are profile deviations of the wheel disc and profile deviations of the blade in the leaf-disc assembly, as shown in FIG. 3. The deviations of the contour degree of the matching surface of the tenon and the mortise and tenon groove, and their rotational quantities are characterized in the respective coordinate systems as follows:

T=[0 0 δw δα δβ 0]^{T} (1)

The wheel center coaxiality deviation, whose spin volume is characterized as follows:

T=[0 δv 0 0 δβ δγ]^{T} (2)

The deviation of the leaf tip position relative to the leaf root is characterized by the following spin volume:

T=[δu δv δw 0 0 0]^{T} (3)

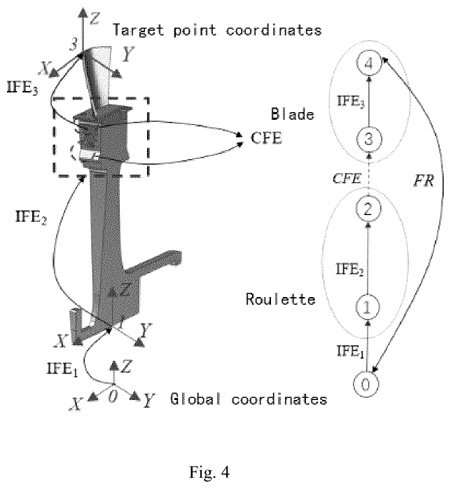

Step 3, leaf-disk structure dimensional chain transfer direction as shown in FIG. 4, the deviation from the center of the wheel disk to the tongue and groove joint structure, and then to the blade tip. The overall view is in a tandem form. However, due to the numerous matching surfaces of the tenon joints in the leaf-disk structure, the deviation transfer path is uncertain and has the characteristics of a typical local complex parallel dimensional chain. Here, the matched connection form of tenon and mortise is used as an equivalent rotational model of the contacting vice. Specifically, as the following small steps:

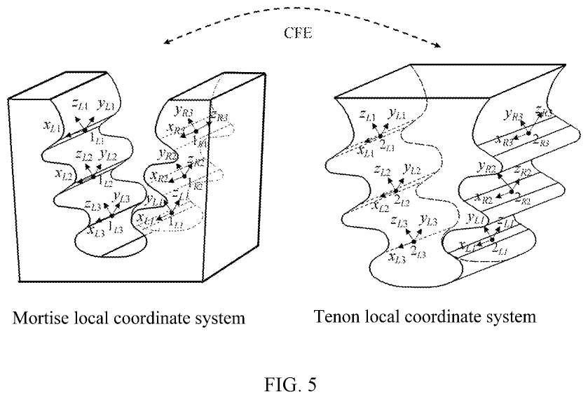

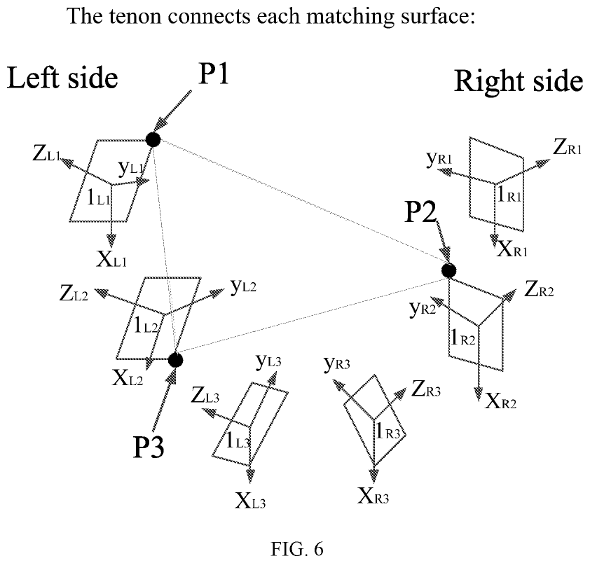

Based on the spatial position of the matching surfaces of the mortise and tenon joint structure, a local coordinate system is established at the center of each matching surface of the mortise and tenon slot, as shown in FIG. 5. According to the spin volume model of deviation in step 2, the plane equation of each matching surface with deviation is established.

Specifically, for any tenon and slot matching surface, the deviation in the local coordinate system is expressed as follows:

Δ [symbol] _{1Li}=δw_{1Li}+δα_{1Li}·y−δβ_{1Li}·x_{Left side} (4)

Δ [symbol] _{1Ri}=δw_{1Ri}−δα_{1Ri}·y+δβ_{1Ri}·x_{Right side} (5)

Similarly, the z-directional deviation of each matching surface of the tenon is expressed as follows:

Δ [symbol] _{2Li}=δw_{2Li}+δα_{2Li}·y−δβ_{2Li}·x_{Left side} (6)

Δ [symbol] _{2Ri}=δw_{2Ri}−δα_{2Ri}·y+δβ_{2Ri}·x_{Right side} (7)

In the formula, subscript i represents the I-th matching surface of the tenon structure, subscript L and R represent the left and right sides, and 1 and 2 represent the mortise and tenon, respectively.

Calculate the amount of interference between each position of the matching surface of the mortise and tenon slot, and use the point of interference as the actual contact point P during assembly. amount of interference:

Δ [symbol] ₍₁₋₂₎ᵢ=Δ [symbol] ₁ᵢ−Δ [symbol] ₂ᵢ (8)

P_ [symbol] =max[Δ [symbol] ₍₁₋₂₎ᵢ] (9)

Considering the positioning stability, at least three points are needed to determine the positioning surface, and at the same time, the area formed by the positioning points should be large enough. Here, the four points with the largest amount of excess are selected from the front, back, left and right sides respectively, and the first three points from these four points are selected as the actual positioning points, as shown in FIG. 6.

Further, the nominal local coordinates of the positioning points are:

$$\\ \begin{matrix}[ \begin{matrix}P {1}_{1}^{0} \\ P {2}_{1}^{0} \\ P {3}_{1}^{0}\end{matrix} ] = [ \begin{matrix}{x}_{p 1} & {y}_{p 1} & 0 \\ {x}_{p 1} & {y}_{p 2} & 0 \\ {x}_{p 1} & {y}_{p 3} & 0\end{matrix} ] & ( 10 )\end{matrix}$$

Further, the actual local coordinates of the registration point:

$$\\ \begin{matrix}[ \begin{matrix}P {1}_{1}^{*} \\ P {2}_{1}^{*} \\ P {3}_{1}^{*}\end{matrix} ] = [ \begin{matrix}{x}_{p 1} & {y}_{p 1} & Δ {𝓏}_{p 1} \\ {x}_{p 1} & {y}_{p 2} & Δ {𝓏}_{p 2} \\ {x}_{p 1} & {y}_{p 3} & Δ {𝓏}_{p 3}\end{matrix} ] & ( 11 )\end{matrix}$$

Based on the actual positions of points P1, P2 and P3, and the coordinate system in which they are located, the equivalent positioning planes with deviations are established. Specifically, it is necessary to obtain the nominal positions of the equivalent positioning points in the global coordinate system and the actual positions with deviation first. Based on the position and angle relationships between the local and global coordinate systems, the coordinate system conversion matrix is established as follows:

$$\\ \begin{matrix}[ \begin{matrix}x \\ y \\ 𝓏\end{matrix} ] = [ \begin{matrix}1 & 0 & 0 \\ 0 & cos θ & - sin θ \\ 0 & sin θ & cos θ\end{matrix} ] [ \begin{matrix}{x}_{L} \\ {y}_{L} \\ {𝓏}_{L}\end{matrix} ] + [ \begin{matrix}{U}_{0 L} \\ {V}_{0 L} \\ {W}_{0 L}\end{matrix} ] Left side & ( 12 )\end{matrix}$$

$$\\ \begin{matrix}[ \begin{matrix}x \\ y \\ 𝓏\end{matrix} ] = [ \begin{matrix}1 & 0 & 0 \\ 0 & - cos θ & sin θ \\ 0 & sin θ & cos θ\end{matrix} ] [ \begin{matrix}{x}_{R} \\ {y}_{R} \\ {𝓏}_{R}\end{matrix} ] + [ \begin{matrix}{U}_{0 R} \\ {V}_{0 R} \\ {W}_{0 R}\end{matrix} ] Right side & ( 13 )\end{matrix}$$

Specifically, U0, V0, W0 are the spatial distances between the local coordinate system of the matching surface and the global coordinate system. The nominal coordinates of the mortise and tenon connection locus in the global coordinate system are as follows:

P1=(xₚ₁,yₚ₁, [symbol] ₚ₁,);P2=(xₚ₂,yₚ₂, [symbol] ₚ₂,);P3=(xₚ₃,yₚ₃, [symbol] ₚ₃,) (14)

The coordinates of the locating point of the mortise and tenon joint structure with deviations in the global coordinate system are as follows:

P1*=(x*ₚ₁,y*ₚ₁, [symbol] *ₚ₁,);P2*=(x*ₚ₂,y*ₚ₂, [symbol] *ₚ₂,);P3*=(x*ₚ₃,y*ₚ₃, [symbol] *ₚ₃,) (15)

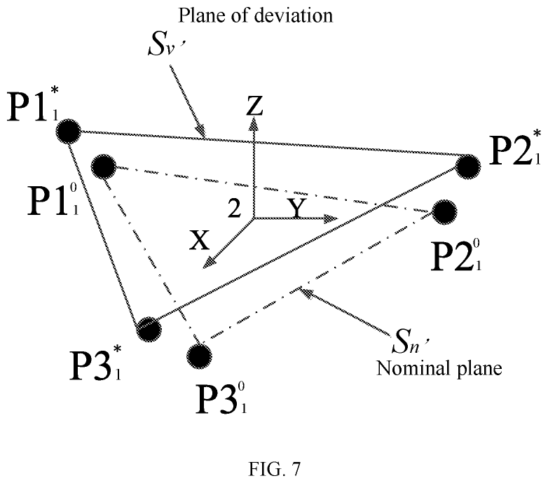

As shown in FIG. 7, the nominal plane equations and the plane equations with deviations for the equivalent positioning surface of the mortise and tenon joint structure in the global coordinate system are as follows:

$$\\ \begin{matrix}{A}^{*} x + {B}^{*} y + {D}^{*} = 𝓏 ( Deviation ) & ( 16 )\end{matrix}$$

$$\\ \begin{matrix}{A}_{0} x + {B}_{0} y + {D}_{0} = 𝓏 ( nominal ) & ( 17 )\end{matrix}$$

$$\\ \begin{matrix}A = \frac{( {𝓏}_{p 2} - {𝓏}_{p 1} ) \cdot ( {y}_{p 3} - {y}_{p 1} ) - ( {y}_{p 2} - {y}_{p 1} ) \cdot ( {𝓏}_{p 3} - {𝓏}_{p 1} )}{( {x}_{p 2} - {x}_{p 1} ) \cdot ( {y}_{p 3} - {y}_{p 1} ) - ( {x}_{p 3} - {x}_{p 1} ) \cdot ( {y}_{p 2} - {y}_{p 1} )} & ( 18 )\end{matrix}$$

$$\\ \begin{matrix}B = \frac{( {x}_{p 2} - {x}_{p 1} ) \cdot ( {𝓏}_{p 3} - {𝓏}_{p 1} ) - ( {x}_{p 3} - {x}_{p 1} ) \cdot ( {𝓏}_{p 2} - {𝓏}_{p 1} )}{( {x}_{p 2} - {x}_{p 1} ) \cdot ( {y}_{p 3} - {y}_{p 1} ) - ( {x}_{p 3} - {x}_{p 1} ) \cdot ( {y}_{p 2} - {y}_{p 1} )} & ( 19 )\end{matrix}$$

$$\\ \begin{matrix}D = - A \cdot {x}_{p 1} - B \cdot {y}_{p 1} + {𝓏}_{p 1} & ( 20 )\end{matrix}$$

Similarly, the nominal equation of the locating surface of the tenon and the plane equation with deviations can be obtained.

The deviation of the deviation plane with respect to the nominal plane can be obtained according to the spin volume model. Here the deviation of the deviation plane with respect to the nominal plane is defined as.

T=[0 0 δw* δα* δβ* 0]^{T} (22)

Specifically, considering the transformation of the coordinate system, the points (x*, y*, [symbol] *) on the equivalent positioning plane with deviations can be represented by the positioning points on the nominally defined plane and the angular and positional deviations.

$$\\ \begin{matrix}[ \begin{matrix}{x}^{*} \\ {y}^{*} \\ {𝓏}^{*}\end{matrix} ] = [ \begin{matrix}cos δ {β}^{*} & sin δ {α}^{*} sin δ {β}^{*} & - sin δ {β}^{*} cos δ {α}^{*} \\ 0 & cos δ {α}^{*} & sin δ {α}^{*} \\ sin δ {β}^{*} & - cos δ {β}^{*} sin δ {α}^{*} & cos δ {β}^{*} cos δ {α}^{*}\end{matrix} ] [ \begin{matrix}{x}_{L} \\ {y}_{L} \\ {𝓏}_{L}\end{matrix} ] + [ \begin{matrix}0 \\ 0 \\ δ {w}^{*}\end{matrix} ] & ( 23 )\end{matrix}$$

Further, by substituting the above equation into the plane equation, the amount of rotation of the deviation plane with respect to the nominal plane can be obtained as follows:

$$\\ \begin{matrix}{m}_{1} = {A}^{*} A + 1 ; {n}_{1} = - {A}^{*} B ; {c}_{1} = {A}^{*} - A ; & ( 24 )\end{matrix}$$

$$\\ {m}_{2} = {B}^{*} A + 1 ; {n}_{2} = - ( {B}^{*} B + 1 ) ; {c}_{2} = {B}^{*} - B ;$$

$$\\ \begin{matrix}δ {α}^{*} = \frac{{c}_{2} {m}_{1} - {c}_{1} {m}_{2}}{{n}_{1} {m}_{2} - {n}_{2} {m}_{1}} , {δβ}^{*} = - \frac{{c}_{2}}{{m}_{2}} - \frac{{n}_{2}}{{m}_{2}} \frac{{c}_{2} {m}_{1} - {c}_{1} {m}_{2}}{{n}_{1} {m}_{2} - {n}_{2} {m}_{1}} , & ( 25 )\end{matrix}$$

$$\\ δ {w}^{*} = {D}^{*} - {D}_{0}$$

Similarly, the equivalent amount of rotation of the locating surface of the tenon can be obtained.

Step 4: On the basis of the spin volume model obtained in steps 1-3, the dimensional chain model of the leaf-disk structure is established using Jacobi-spin volume theory. Specifically, the deviation model presented by Jacobi-spin volume theory adopts the following definition: Function element (FE), i.e., the geometric feature elements between individual parts or components in the assembly, which can be solid elements or virtual elements. For example, the cylindrical column surface, end face features, is a solid element; or cylindrical rotation axis, is a virtual element. Internal function element (IFE), located in the internal geometric features of a single part, they exist between each other constraints, two constitute an internal constraint pair, referred to as internal vice. Contact function element (CFE), geometric elements located on different parts connecting features, there is a direct or indirect contact between them, two form an external constraint pair, referred to as the contact pair. Functional requirement (FR), i.e. the dimensional accuracy requirement of the closed ring, is the target measurement and control quantity after the final assembly is completed.

According to the assembly state of the leaf-disk structure, the functional units in its dimensional chain are represented as shown in FIG. 4, where the functional requirement FR is the position deviation of the blade tip relative to the global coordinate system, the coaxial deviation of the wheel disk relative to the global coordinate system is the internal functional unit IFE, the deviation of the matching surface of the tongue and groove of the wheel disk relative to the wheel disk datum is IFE, while the tongue and groove contact with the tongue and groove belongs to the contact functional unit CFE, and the leaf tip relative to the leaf root is IFE.

Further, the Jacobi-spinor theory will introduce the Jacobi matrix into the tolerance transfer. The Jacobi matrix is mainly used to characterize the transfer and accumulation of deviations in the geometric functional element (FE) of the leaf-disk structure in three-dimensional space, and can characterize the spatial location relationship between the ith FE deviation feature and the target deviation feature (Functional requirement, FR), whose expression is as follows:

$$\\ \begin{matrix}{J}_{FEi} = [ \begin{matrix}{R}_{0}^{i} {R}_{Pti} & {W}_{i}^{n} ( {R}_{0}^{i} {R}_{Pti} ) \\ 0 & {R}_{0}^{i} {R}_{Pti}\end{matrix} ] & ( 26 )\end{matrix}$$

Specifically, R₀ⁱ is a 3×3 direction matrix, which is the direction matrix between the ith FE with respect to the global coordinate system “0”. It characterizes the directional transformation of the coordinate system in which the ith element is located. Specifically, R₀ⁱ is defined as follows:

R₀ⁱ=[C₁ₗC₂ₗC₃ₗ] (27)

Specifically, the elements C11, C21 and C31 are unit vectors that represent the projection vectors of the ith element sitting in the local coordinate system tri-coordinate with respect to the global coordinate system “0” tri-coordinate direction, which correspond to the x, y and z axis directions, respectively.

$$\\ \begin{matrix}{W}_{i}^{n} = [ \begin{matrix}0 & d {𝓏}_{i}^{n} & - {dy}_{i}^{n} \\ - d {𝓏}_{i}^{n} & 0 & {dx}_{i}^{n} \\ {dy}_{i}^{n} & - {dx}_{i}^{n} & 0\end{matrix} ] & ( 28 )\end{matrix}$$

Specifically, Wᵢⁿ is the antisymmetric matrix for representing the 3D distance vector between the ith element and the nth element (i.e., the target element), and dxᵢⁿ, dyᵢⁿ, and d [symbol] ᵢⁿ can be calculated by the following equation:

dxᵢⁿ=dxₙ−dxᵢ

dyᵢⁿ=dyₙ−dyᵢ

d [symbol] ᵢⁿ=d [symbol] ₙ−d [symbol] ᵢ (29)

Specifically, dxᵢ, dyᵢ and d [symbol] ᵢ are the distances of the coordinate system where the ith element is located with respect to the global coordinate system in the x, y and [symbol] directions. The product between the direction matrix and the distance matrix, Wᵢⁿ·R₀ⁱ, is used to characterize the leverage effect of the deviation in the transfer process through the Rₚₜᵢ, which is the projection matrix that represents the projection matrix between the direction of the deviation analysis and the tolerance band.

Based on the characterization of the deviation of each functional unit by the spin volume model and the transfer and accumulation of the deviation in space by the Jacobi matrix, the Jacobi-spin volume theory takes the product of the above two as the three-dimensional deviation model. Based on the Jacobi-spinor principle, the deviation model of the blade-disk assembly is established as follows:

$$\\ \begin{matrix}{[ \begin{matrix}δ u \\ δ v \\ δ w \\ δ α \\ δ β \\ δ γ\end{matrix} ]}_{FR} = [ \begin{matrix}{[ J ]}_{FE 1} & {[ J ]}_{FE 2} & {[ J ]}_{CFE} & {[ J ]}_{FE 3}\end{matrix} ] \cdot {[ {{{{[ \begin{matrix}0 \\ δ v \\ δ w \\ 0 \\ δ β \\ δ γ\end{matrix} ]}_{FE 1} [ \begin{matrix}0 \\ 0 \\ δ {w}^{*} \\ δ {α}^{*} \\ δ {β}^{*} \\ 0\end{matrix} ]}_{FE 2} [ \begin{matrix}0 \\ 0 \\ - δ {w}^{*} \\ - δ {α}^{*} \\ - δ {β}^{*} \\ 0\end{matrix} ]}_{CFE} [ \begin{matrix}δ u \\ δ v \\ δ w \\ 0 \\ 0 \\ 0\end{matrix} ]}_{FE 3} ]}^{T} , & ( 30 )\end{matrix}$$

The above equation is the model for analyzing the blade dimensional chain considering the mortise and tenon joint structure established in this embodiment. This model allows prediction and analysis of blade spatial position deviation.

Specifically, based on the relationship between blade and wheel geometry and spatial location in this embodiment, the individual Jacobi matrices in this embodiment are defined as follows:

$$\\ \begin{matrix}{[ J ]}_{FE 1} = [ \begin{matrix}1 & 0 & 0 & 0 & 462.6 & 10.9 \\ 0 & 1 & 0 & - 462.6 & 0 & 24.25 \\ 0 & 0 & 1 & - 10.9 & - 24.25 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] , & ( 31 )\end{matrix}$$

$$\\ \begin{matrix}{[ J ]}_{FE 2} = {[ J ]}_{CFE} = [ \begin{matrix}1 & 0 & 0 & 0 & 462.6 - {D}_{0} & 10.9 \\ 0 & 1 & 0 & - 462.6 + {D}_{0} & 0 & 24.25 \\ 0 & 0 & 1 & - 10.9 & - 24.25 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] , & ( 32 )\end{matrix}$$

$$\\ \begin{matrix}{[ J ]}_{FE 3} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] , & ( 33 )\end{matrix}$$

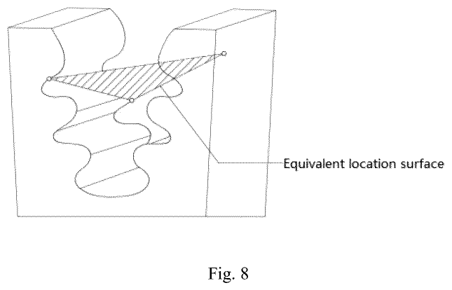

In this embodiment, for the sake of demonstration, the angular deviation δα=−0.005, δβ=0.0004 for the right side of the first tooth of the tenon slot, δα=0.005, δβ=0.0004 for the left side of the first tooth, δα=−0.005, δβ=−0.0004 for the left side of the second tooth, and zero deviation for the rest of the matching surfaces of the tenon slot are defined here. The above deviations are taken as input quantities and brought into the modeling process shown in this example to obtain the equivalent locating surface and locating points of the tenon groove as shown in FIG. 8.

Further, the deviation of the position of the leaf tip is obtained by the deviation analysis model described in this embodiment, as follows:

$$\\ [ FR ] = [ \begin{matrix}δ u \\ δ v \\ δ w \\ δ α \\ δ β \\ δ γ\end{matrix} ] = [ \begin{matrix}- 0.0042 \\ - 0.0475 \\ - 0.0202 \\ 0.0004 \\ - 0.0001 \\ 0\end{matrix} ]$$

Further, it is considered that the form deviations of each key geometric element in actual manufacturing and assembly are random and conform to a certain probability distribution. In order to better show the statistical distribution of the target deviation of the leaf-disk structure assembly and to study the influence of each deviation source on the target deviation, the statistical distribution of the leaf tip position deviation in the case of deviation randomness is considered in this implementation. Here, each deviation source is defined as randomly generated and normally distributed within the specified tolerance domain, and the statistical standard deviation of the deviation is set by one-sixth of the width of the tolerance band, and the probability density function of the normal distribution is as follows:

$$\\ \begin{matrix}f ( x ) = \frac{1}{\sqrt{2 π} σ} exp ( - \frac{{( x - μ )}^{2}}{2 {σ}^{2}} ) & ( 34 )\end{matrix}$$

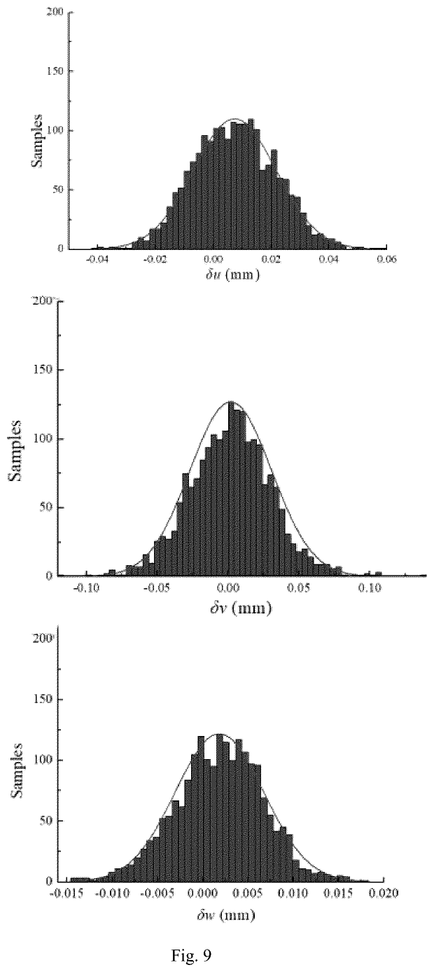

Specifically, σ is the standard deviation and μ is the mean value. Define the contour degree of the matching surface of the mortise and tenon groove are 0.01 mm, and the coaxiality of the wheel is 0.01 mm. the accuracy of the leaf tip position relative to the blade mortise is 0.01 mm. the deviation distribution of the leaf tip position is calculated according to the dimensional chain model described in this example, and the results are shown in FIG. 9.

Specifically, the leaf tip was statistically distributed in the x-direction as shown above with a standard deviation σ=0.0139 mm and a statistical distribution interval[−0.0417 mm,+0.0417 mm]. The statistical distribution of the leaf tip in the y-direction is shown above with a standard deviation σ=0.0294 mm and a statistical distribution interval[−0.0882 mm,+0.0882 mm]. The statistical distribution of leaf tips in the z-direction is shown above with a standard deviation σ=0.0049 mm and a statistical distribution interval [−0.0147 mm,+0.0147 mm].

With the blade dimensional chain modeling method and the established dimensional chain model described in this embodiment, it is possible to equate the local complex parallel dimensional chain of the tenon and mortise groove to a single positioning surface, on the basis of which the leaf tip position deviation as well as the statistical distribution of the target deviation can be calculated.

The above embodiments are only a part of the present invention. The tolerance values and leaf-disk structure geometry dimensions described in the embodiments are only an example, and the results of the target deviations vary accordingly for different tolerance values and dimensions. The analysis of deviations can be carried out by the dimensional chain modeling method described in the embodiment according to the actual engineering structure and requirements. The above described is only a specific implementation of the present invention.

The above mentioned is only a specific implementation of the present disclosure, but the scope of protection of the present disclosure is not limited to it, and any changes or substitutions that can be easily thought of by any person skilled in the art within the technical scope disclosed in the present disclosure shall be covered by the scope of protection of the present disclosure. Therefore, the scope of protection of the present disclosure shall be subject to the scope of protection of the claims.

What is claimed is:

1. A method for modeling a blade dimensional chain considering a tenon-tenon connection, characterized in that it comprises the following steps:
Step 1: establishing the tolerance types of key geometric elements required for the blade dimensional chain model and the tolerance values based on the matching relationship between the blade and the rotor during assembly and the tolerance requirements in the actual manufacturing process;
Step 2: characterize the tolerances of each key geometric element based on the small displacement spin theory and establish the spin model of the deviation of each key geometric element of the wheel-disk-blade;
Step 3: Considering that the mortise and tenon joint structure of the blade-disk has many tenon and tenon slot matching surfaces, which is a typical complex local multi-parallel dimensional chain; taking the matching connection form of the tenon and tenon slot as an equivalent spin model of the contacting pair;
Step 4: Based on the spatial position relationship between each key geometric element of the blade-disk and the blade tip, as well as the spin model of each functional unit in the dimensional chain, the assembly deviation analysis model of the blade-disk structure is established by using Jacobi-spin theory; based on this model, the initial assembly deviation of the blade under the consideration of the tenon connection with the wheel disk and the spatial attitude prediction are characterized;
The specific steps in Step 3 are as follows:
Step 1: The deviations of the matching surfaces of tenon and mortise in the blade-disk assembly are characterized by small displacement rotations, i.e. the actual deviating surfaces have three deviations in x/y/z directions and three deviations in rotation along x/y/z directions with respect to the nominal surface;
Step 2: Establish a local coordinate system at the center of each matching surface, and establish the deviation plane equations for each tenon joint matching surface in the respective coordinate system based on the matching surface rotation and translational deviations;
Step 3: calculating the amount of clearance and interference between the contact points of each matching surface of the tenon of the leaf root and the tenon groove of the wheel disc relative to the nominal value in the installation direction;
Step 4: ranking the corresponding amount of overfill in each of the matching surfaces containing deviations between the tenon and the tenon slot, and using the plane formed by the first three points with the largest amount of overfill as the equivalent positioning plane for the assembly of the tenon and the tenon slot;
Step 5: establishing a coordinate system conversion matrix based on the position relationship between the local coordinate system and the global coordinate system, and using the three positioning points of the equivalent positioning plane in the mortise and tenon joint structure determined in step 4, transforming the positioning points of this equivalent positioning plane into points under the global coordinate system based on the coordinate conversion matrix;
Step 6: establishing the nominal plane equations and the plane equations with deviations for the equivalent locating surfaces of the mortise and tenon joint, respectively, under the global coordinate system;
Step 7: Comparing the plane equation with deviation of the positioning plane obtained in Step 6 with the nominal plane equation to obtain the angular deviation and position deviation of the deviated plane with respect to the nominal equivalence plane, and thus obtain the rotational volume model of the equivalent equivalence plane of the mortise and tenon joint.

2. A method for modeling a blade dimensional chain considering a tenon-tenon connection according to claim 1, characterized in that the key geometric elements required for said blade dimensional chain model include the contour of each matching surface at the blade tenon position, the contour of each matching surface at the rotor tenon slot position, and the position of the blade tip relative to the blade root.

3. The method of modeling a blade dimensional chain considering a mortise-tenon connection according to claim 1, characterized in that the point in the calculation of the excess in step 3 is the excess point and the excess point is used as the actual contact point during assembly.

4. The method for modeling a blade dimensional chain considering a tenon-tenon connection according to claim 1, characterized in that the following definitions are used in the assembly deviation analysis model of the blade-disk structure built using Jacobi-spinor theory: the geometric feature elements of individual parts or between parts in the assembly are functional units; internal functional units, geometric feature elements located inside a single part, between which there exists a mutual The internal functional units are the geometric feature elements located inside the single parts, which have a binding relationship with each other and constitute an internal binding pair, or internal pair for short; the contact functional units are the geometric elements located on the connecting features of different parts, which have a direct or indirect contact relationship with each other and constitute an external binding pair, or contact pair for short; the functional requirements, i.e. the dimensional accuracy requirements of the closed ring, are the target measurement and control quantities after the final assembly is completed.

5. The method for modeling a blade dimensional chain considering a tenon-tenon connection according to claim 4, characterized in that the geometric feature elements include solid elements and virtual elements; wherein the column and end face features of the cylinder are solid elements and the cylindrical rotation axis is a virtual element.
